(19) United States
(12) Patent Application Publication
(10) Pub. No.: US 2007/0077921 A1
(43) Pub. Date: Apr. 5, 2007

(54) Pushing podcasts to mobile devices

(75) Inventors: Nathanael Joe Hayashi, Piedmont, CA (US); Edward Stanley Ott IV, Palo Alto, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/417,610

(22) Filed: May 3, 2006

Related U.S. Application Data
(63) Continuation-in-part of application No. 11/346,777, filed on Feb. 2, 2006.
(60) Provisional application No. 60/722,600, filed on Sep. 30, 2005.

(51) Int. Cl. H04Q 7/38

(52) U.S. Cl. 455/414.1

(57) ABSTRACT

The present invention relates to a system and method for pushing podcasts to mobile devices, such as cellular phones, from a remote subscription management system. A subscription management system is described that is adapted to retrieve episodes from one or more remote computing devices and transmit retrieved episodes to a mobile device over a wireless network. The transmissions are made via a telephone number associated with the mobile device. The system includes a datastore, in communication with the server, containing at least one telephone number of a mobile device associated with a user and at least one podcast subscription associated with the user. The podcast lists episodes that are located on one or more of the remote computing devices. When a search module identifies a new episode, the system retrieves the new episode and transmits it to the mobile device using the telephone number to address the transmission.

### RELATED APPLICATIONS

This application claims the benefit of U.S. Provisional Application No. 60/722,600, filed Sep. 30, 2005, which application is hereby incorporated herein by reference. This application is a continuation-in-part of prior application Ser. No. 11/346,777, filed Feb. 2, 2006, which application is hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The expansion of the Internet and the World Wide Web (“web”) has given computer users the enhanced ability to listen to and to watch various different forms of media content through their computers. Such content can be in the form of audio music, music videos, television programs, sporting events or any other form of audio or video content that a user wishes to watch, read, listen to or otherwise perceive in some manner.

Multimedia data files, or media files, are data structures that may include audio, video or other content stored as data in accordance with a container format. A container format is a file format that can contain various types of data, possible compressed a standardized and known manner. The container format allows a rendering device to identify, and if necessary, interleave, the different data types for proper rendering. Some container formats can contain only audio data, while other container formation can support audio, video, subtitles, chapters and metadata along with synchronization information needed to play back the various data streams together. For example, an audio file format is a container format for storing audio data. There are many audio-only container formats including known in the art including WAV, AIFF, FLAC, WMA, and MP3. In addition, there are now a number of container formats for use with combined audio, video and other content including AVI, MOV, MPEG-2 TS, MP4, ASF, and RealMedia to name but a few.

Media files accessible over a network are increasingly being used to deliver content to mass audiences. For example, one emerging way of periodically delivering content to consumers is through podcasting.

Podcasting is a method of publishing digital media, typically audio or video programs, via the Internet, allowing users to subscribe to a series of new files (e.g., .MP3 audio files) as they become available over time. The word “podcasting” became popular in late 2004, largely due to automatic downloading of audio onto portable players or personal computers. Podcasting is distinct from other types of online media delivery because of its subscription model, which uses a “feed” (such as RSS, discussed below, and Atom) to monitor for and/or deliver a file. A feed in this context refers to an electronic means, such as a file containing a list of media files (referred to as “episodes” of the feed), that can be easily interpreted to identify new episodes in the list as the episodes are added over time. Specialized software on the user's computer may be used to occasionally check the feed for new episodes. Thus, one is said to subscribe to a feed because as new episodes are listed in the feed, the subscriber (via the software) is notified of the new file and, in some cases, the new file is automatically retrieved by the software.

Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and may download new content automatically. Most podcatching software enables the user to copy podcasts to portable music players. Most digital audio player or computer with audio-playing software can play podcasts. From the earliest RSS-enclosure tests, feeds have been used to deliver video files as well as audio. By 2005 some aggregators and mobile devices could receive and play video, although the “podcast” name remains most associated with audio. Other names are sometimes used for casting other forms of media, such as blogcasting for text and vcasting, vlogging or vodcasting for video. For the purposes of this application, podcast is used in its most general sense to refer to a list of new files in any format (e.g., .MP3, .MPEG, .WAV, .JPG) and containing any content (e.g., text-based, audible, visual or some combination) that can be subscribed to. Also, for the purposes of this discussion an individual podcast feed may be alternately referred to as a series. Each distinct new file in a series or feed may be referred to as an individual episode of the series.

Podcasting is supported by underlying feed formats, of which RSS is but one example. RSS is a family of XML file formats for web syndication used by (among other things) news websites and weblogs. The abbreviation is alternately used to refer to the following recognized standards: Rich Site Summary (RSS 0.91); RDF Site Summary (RSS 0.9 and 1.0); and Really Simple Syndication (RSS 2.0).

Feed formats, such as the RSS formats, often allow the feed creator (referred to as the publisher) to include web content or summaries of web content together with links to the full versions of the content, and other meta-data. This information may be associated with different episodes of the feed, thus allowing an easy way to provide at least some summary information to the subscriber so that a subscriber does not have to render each episode to determine if it contains information of interest. This information may be delivered within an XML feed file, a webfeed, an RSS stream, or RSS channel.

The technology behind podcasting allows a client to subscribe to websites that have provided RSS feeds or feeds in other formats; these are typically sites that change or add content regularly. To use this technology the client needs some type of RSS aggregation service or aggregator. The aggregator allows a client to subscribe to the podcasts that the client wants to monitor or to get updates (i.e. future media files in the feed) on. Unlike typical subscriptions to pulp-based newspapers and magazines, RSS subscriptions are free, but they typically only provide a line or two of each article or post along with a link to the media file that contains the episode (e.g., the full text article, audio file or video file). In addition to facilitating syndication, a feed allows a website's frequent readers to track updates on the site using an aggregator.

Feeds, including RSS feeds, are widely used by the weblog community to share the latest episodes' headlines or their full text, and even attached multimedia files. In mid 2000, use of RSS for podcasting text spread to many major news organizations, including Reuters, CNN and the BBC, until under various usage agreements, providers allow other websites to incorporate their “syndicated” headline or headline-and-short-summary feeds. Feeds are now used for many purposes, including marketing, bug-reports, or any other activity involving periodic updates or publications.

Podcasting has become a very popular and accepted media delivery paradigm. This success has caused the number and variety of podcasts available to clients to grow exponentially. Potential podcast consumers are now confronted with the problems of how to find podcasts; how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

### SUMMARY OF THE INVENTION

The present invention relates to a system and method for pushing podcasts to mobile devices, such as cellular phones, from a remote subscription management system. In this way, the user does not need podcatching software on the user's mobile device. The mobile device does not need to actively search for or retrieve new episodes. The mobile device also does not to be actively synchronized with another system such as a computing system that has podcatching software.

In the subscription management system, a server is adapted to retrieve episodes from one or more remote computing devices and transmit retrieved episodes to a mobile device over a wireless network. The transmissions are made via a telephone number associated with the mobile device. The system includes a datastore, in communication with the server, containing at least one telephone number of a mobile device associated with a user and at least one subscription associated with the user. The at least one subscription corresponds to a podcast accessible via one of the one or more remote computing devices. The podcast lists episodes that are again located on one or more of the remote computing devices. The system also includes a search module adapted to identify that a new episode has been listed in the podcast. When the search module identifies the new episode, the server is adapted to retrieve the new episode based on information in the podcast and transmit the new episode to the mobile device associated with the user, using the telephone number of the mobile device to ensure that the new episode is addressed properly.

In one example (which example is intended to be illustrative and not restrictive), the present invention may be considered a method for having new episodes delivered to a mobile device. The method includes transmitting a first telephone number of a mobile device to a subscription management system on a first remote computing device. A feed located on a second remote computing device is associated with the first telephone number of the mobile device. As a result, the mobile device later receives, from the subscription management system via a wireless network, new episodes listed in the feed located at the second remote computing device as the episodes become available.

In another example (which example is intended to be illustrative and not restrictive), the present invention may be considered a method of delivering episodes of a subscription to a mobile device on a wireless network. The method includes maintaining, by a subscription management system remote from a mobile device, user data associating a telephone number of a mobile device with at least one user-selected subscription maintained at a computing device remote from the subscription management system and the mobile device. The method further includes determining that a new episode has been added to one of the at least one user-selected subscription. The subscription management system transmits a notification of the new episode to the wireless network, the notification associated with the telephone number, thereby delivering the notification to the mobile device via the wireless network.

Additional features of the invention will be set forth in the description which follows, and in part will be apparent from the description, or may be learned by practice of the invention. The benefits and features of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is a flowchart depicting a high-level embodiment of a method for pushing podcast subscriptions to a mobile device.

FIG. 2 is an illustration of an exemplified embodiment of architecture for a subscription management system that can push new episodes of a subscription to mobile devices.

FIG. 3 is a flowchart depicting an embodiment of a method for having new episodes of a podcast pushed to a mobile device.

FIG. 4 is a flowchart depicting an embodiment of a method for pushing new episodes of a podcast to a mobile device.

### DETAILED DESCRIPTION OF PREFERRED EMBODIMENTS

In general, the specification discusses a system and method for managing subscriptions to podcasts so that new episodes are pushed to a user's mobile device from a subscription management service. In the system, the subscription management service maintains the user information, such as the mobile device's contact information and information identifying the user's subscriptions. The system also includes a search module that periodically or occasionally determines if new episodes have been added to the user's subscriptions. The mobile device has no knowledge of the subscript

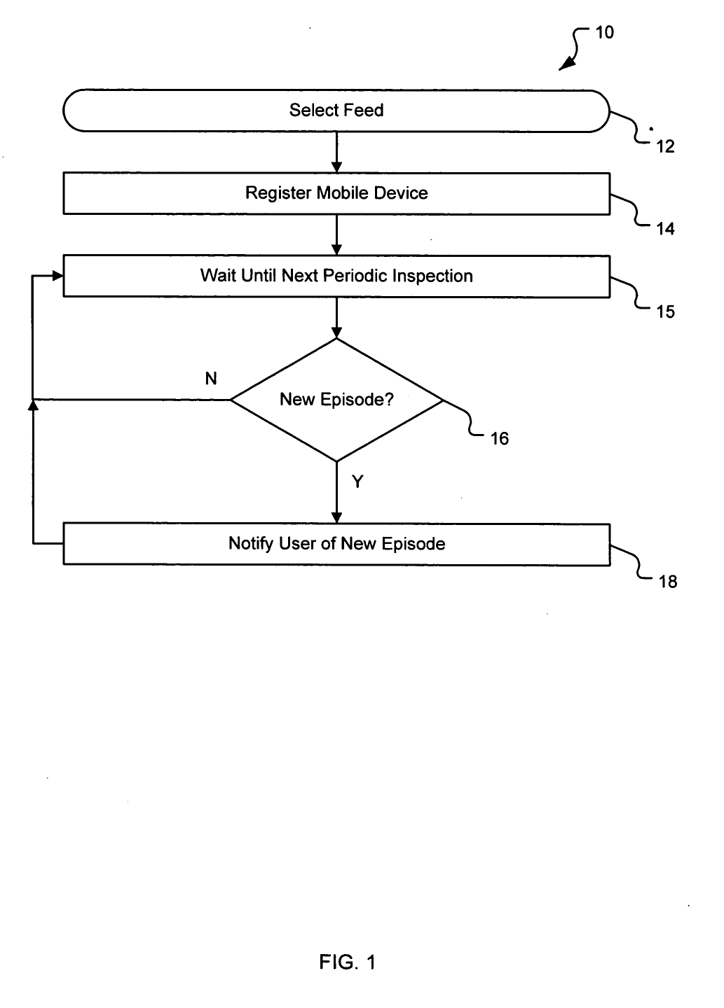

FIG. 1 is a flowchart depicting a high-level embodiment of a method for pushing podcast episodes to a mobile device. In the embodiment of the method 10 shown, a user interacts with the system to select (i.e., subscribe to) one or more podcast feeds, and transmit those selections to a subscription management system, in a feed selection operation 12. The user also provides to the subscription management system a telephone number or other identifier of the user's mobile device that the user wishes new episodes to be pushed to in a register mobile device operation 14. As time progresses and new episodes are added to the selected feeds, the subscription management system periodically inspects the selected feeds to identify new episodes. In the embodiment 10, this is illustrated by a waiting operation 15 in which the system is idle until the next inspection.

One example of a feed search engine is described in commonly assigned U.S. patent application Ser. No. 11/346,777, filed Feb. 2, 2006 which is hereby incorporated herein by reference. However, any suitable search engine or method may be used, whether now known or later invented.

In a periodic or occasional inspection, the subscription management system accesses the selected feeds and compares the current version of the feed with information stored by the system to identify any new episodes that have been added since the last inspection in a new episode determination operation 16. If there is not a new episode, then the system waits for the next inspection in the wait operation 15.

If there is a new episode, the system then notifies the mobile device of the new episode in a notification operation 18. In an embodiment, the mobile device is cellular phone and the system uses the telephone number of the mobile device received in the register mobile device operation 14 to transmit the notification to the mobile device using the cellular phone network through which the mobile device communicates.

In one embodiment, the notification operation 18 may include retrieving the episode based on information in the feed from the remote computing device that stores it and transmitting the retrieved episode to the mobile device.

The method described above allows the user to manage subscriptions centrally at the subscription management system, but automatically receive new episodes at the user's mobile device. Furthermore, the mobile device itself needs not be subscribed to the feed nor waste the device's resources with an aggregator or other subscription management software. In addition, the user need not “synchronize” the mobile device by accessing an aggregator on the user's local computer.

As used herein, the terms “episode,” “content”, “media”, or “media files” are used broadly to encompass any product type or category of renderable, experienceable, retrievable, computer-readable filed and/or stored media, either singly or collectively, and individual items of media or content are generally referred to as entries, songs, tracks, pictures, images, items or files, however, the use of any one term is not to be considered limiting as the concepts features and functions described herein are generally intended to apply to any storable and/or retrievable item that may be experienced by a user, whether aurally, visually or otherwise, in any manner now known or to become known. Further, the term content includes all types of media content such as audio and video and products embodying the same.

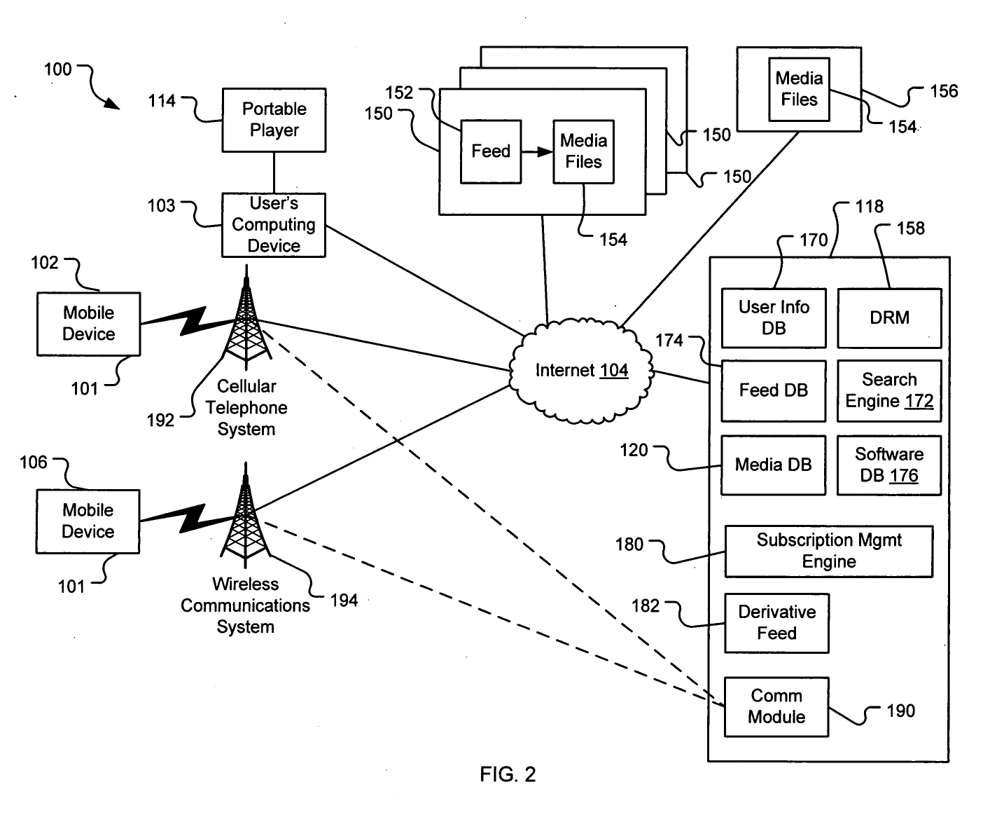

FIG. 2 is a computing architecture illustrating an embodiment of a subscription management system for pushing podcast episodes to mobile devices. Although numerous exemplary embodiments will be discussed in terms of music and/or audio files, this invention can also be utilized with any form of audio, video, digital or analog media content, as well as any other media file type now known or to become known. In addition, although numerous exemplary embodiments will also be discussed in terms of mobile cellular phones that communicate through the cellular telephone system of base stations, this invention can also be utilized with any form of mobile device that can communicate with the subscription management system over any network now known or to become known.

The system shown in FIG. 2 includes a subscription management server 118 that pushes episodes to mobile devices 101. Examples of mobile devices 101 include any computing device that can wirelessly communicate with a network such as the Internet 104 with the subscription management server 118 and through which a user may experience (e.g., play or render) the content of an episode at any location with wireless service. Examples of mobile devices 101 include smart phones, personal data assistants (PDAs) that have wireless access to a network 104, portable computers provided with wireless network cards or modems, Blackberry®-type mobile e-mail devices, web-enabled car stereos, and satellite receivers.

FIG. 2 illustrates two such mobile devices 101: a cellular phone 102 served by a cellular telephone system and network 192 that includes cellular telephone communication transmitting and receiving towers that transmit wireless data to the cellular phone 102; and a web-enabled mobile device 106 that communicates wirelessly with a non-cellular telephone-based wireless communication network 194 through a transmitter/receiver 108, such as a wi-fi network, a WiMAX (802.16) network, a satellite network or some other non-cellular telephone network. While, such wireless networks 192, 194 may include significant traditional “wired” networks and equipment, for example the traditional telephone infrastructure often referred to as “plain old telephone system” (POTS) or the publicly switched telephone network (PSTN), they are distinguished by their wireless capability to support wireless mobile devices.

FIG. 2 includes a user's computing device 103. In an embodiment, a user may use the computing device 103 to directly interact with the subscription management server 118. The computing device 103 may be a personal computer (PC) or other computing device that is considered “non-mobile” in that it maintains a fixed location and thus does not have to negotiate communication connections with different hardware due to a change in location.

In an embodiment, a computing device 103 includes an Internet browser (not shown), such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users.

Computing device 103 also may be connectable to one or more portable devices 114 such as a compact disc player and/or other external media file player, commonly referred to as an MP3 player, such as the type sold under the trade name iPod by Apple Computer, Inc., that is used to portably store and play media files. Such a portable device 114 is differentiated from a mobile device 101 in that a portable device 114 is not able to connect to the subscription management server 118, but rather must connect to the user's computing device 103 to obtain media from or through the computing device 103, such as through a synchronization process.

Local files may be stored on a mass storage device (not shown) that is connected to or part of any of the computing devices described herein including a mobile device 101, the computing device 103 or a server 118, 150, 156. A mass storage device and its associated computer-readable media, provide non-volatile storage for the computing device 103. Although the description of computer-readable media contained herein refers to a mass storage device, such as a hard disk or CD-ROM drive, it should be appreciated by those skilled in the art that computer-readable media can be any available media that can be accessed by the computing device 103.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

The architecture 100 also includes subscription management server 118. In addition to serving media over the Internet 104 to the user, subscription management server 118 also may include a media database 120, which stores or communicates with storage of various metadata attributes of each particular piece of media. Database 120 may be distributed over multiple servers or locations. Other servers (not shown) make other content and services available through or for the subscription management server 118 and may provide administrative services such as managing user logon, service access permission, digital rights management, and other services made available through a service provider. Although some of the embodiments of the invention are described in terms of music, embodiments can also encompass any form of streaming or non-streaming media including but not limited to news, entertainment, sports events, TV episodes, web page or perceptible audio or video content. It should also be understood that although the present invention is described in terms of media content and specifically audio content, the scope of the present invention encompasses any content or media format heretofore or hereafter known.

The subscription management server 118 also includes a database 170 of user information. The user information database 170 includes information about users that is collected from users or generated by the subscription management server 118 as the user interacts with the subscription management server 118. In one embodiment, the user information database 170 includes user information such as user name, gender, e-mail and other addresses, user preferences, etc. that the user may provide to the subscription management server 118. In addition, the server 118 may collect information such as what podcasts the user has subscribed to (i.e., the user's subscriptions), what searches the user has performed, how the user has rated various podcasts, etc. In effect, any information related to the user and the podcasts that user subscribes to that is available to the subscription management server 118 may be stored in the user information database 170.

For example, in one embodiment a user may use the subscription management server as a central manager of the user's subscriptions, instead of having multiple devices 103, each subscribed to different feeds. In this embodiment, all subscription information associated with the user is stored in the user information database 170, including the list of feeds that the user is currently subscribed to. This subscription information is updated over time to reflect user actions such as subscribing to new feeds, unsubscribing to feed, and listening to various episodes of feeds.

The user information database 170 may also include information about a user's device or devices 101, 103, 114. The information allows the subscription management server 118 to identify each device and differentiate it from the other devices associated with the user. Furthermore, it is anticipated that a single user may have multiple different computing devices 103 and mobile devices 101. The subscription management server 118 is capable of associating each of these devices with the user (such as by a user's account) and differentiating between the devices.

For example, the user information database 170 may store information for each device known to the subscription management server 118 that is associated with the user. In an embodiment, the information stored is provided by the device 102, 103, 106. This may include storing a telephone number of a smart phone 102 or a device ID for a mobile device 106. In another embodiment, the information is initially generated by the subscription management server 118, such as in response to the user registering the device 102, 103, 106 with the server 118, and then stored on the device 102, 103, 106 by subscription management server 118. A cookie is a common example of identification information generated by a server for storage on a computing device. In this case, the information in the cookie is stored in the user information database 170 for future identification of the device.

In addition to storing information for each device associated with a particular user, the subscription management server 118 also stores information concerning what of the user's subscriptions are associated with each of the user's devices 102, 103, 106. The subscription management server 118 then uses this information to determine where to send notifications and new episodes of feeds. For example, a user with multiple devices 102, 103, 106 may direct the subscription management server 118 to automatically send new episodes of one feed 152 to one or more devices 102, 103, 106 and notifications that new episodes are available in a different feed 152 to a different device 102, 103, 106. The user, through the subscription management server 118, then has centralized control over what is delivered to each device.

In the embodiment shown, the subscription management server 118 includes a feed database 174. The feed database 174 may include a list of podcasts 152 known to the server 118. This list may be periodically refreshed as the server 118 searches for new feeds 152 and for feeds 152 that have been removed from access to the Internet 104. Such a feed database 174 may not be necessary if the searching ability of the server 118 is sufficient to quickly provide user with updated and accurate feed information in response to a user search. The feed database 174 may include all of the information provided by the feed 152. In addition, the feed database 174 may include other information generated by the subscription management server 118 or by users. Thus, the feed database 174 may contain information not known to or generated by the publisher of the feed 152.

In an embodiment, the feed database 174 includes additional information regarding feeds 152 in the form of “tags.” A tag is a keyword chosen by a person accessing the subscription management server 118 to describe a particular feed 152. The tag can be any word or combination of key strokes. Each tag submitted to the subscription management server may be recorded in the feed database 172 and associated with the feed the tag describes. Tags may be associated with a particular feed 152 (e.g., a series tag) or associated with a specific media file 154 within the feed 152 (e.g., an episode tag). Tags will be discussed in greater detail below.

Since tags can be any keyword, a typical name for a category, such as “science” or “business,” may also be used as a tag and in an embodiment the initial tags for a feed are automatically generated by taking the category designations from a feed and using them as the initial tags for the feed. However, note that tags are not a hierarchical category system that one “drills down” through. Tags are not hierarchically related as is required in the typical categorization scheme. Tags are also cumulative in that the number of users that identify a series or an episode with a specific tag are tracked. The relative importance of the specific tag as an accurate description of the associated content (i.e., series or episode) is based on the number of users that associated that tag with the content.

In an embodiment, consumers of feeds 152 are allowed to provide information to be associated with feeds or particular episodes. Thus, the user after consuming data may rate an episode, say on a scale of 1-5 stars, write a review of the episode, and enter tags to be associated with the episode. All this consumer-generated data may be stored in the feed database 174 and associated with the appropriate episode for use in future searches. For example, in an embodiment such community generated information is used as part of the determination operation 18 to determine if an episode conforms to specified filter criteria.

In one embodiment, the search engine 172, discussed below, creates a new entry in the feed database 174 for every feed 152 it finds. Initially, the entry contains some or all of the information provided by the feed 152. An automatic analysis may or may not be performed to match the feed 152 to known tags based on the information provided in the feed 152. For example, in an embodiment some RSS feeds include a category element and the categories listed in that element for the feed are automatically used as the initial tags for the feed. While this is not the intended use of the category element, it is used as an initial tag as a starting point for the generation of more accurate tags for the feed. Note that searches on terms that appear in the feed 152 will return that feed as a result, so it is not necessary to provide tags to a new entry for the search to work properly. Initially no ratings information or user reviews are associated with the new entry. The manager of the subscription management server may solicit additional information from the publisher such as the publisher's recommended tags and any additional descriptive information that the publisher wishes to provide but did not provide in the feed 152 itself.

The feed database may also include such information as reviews of the quality of the feeds, including reviews of the series as a whole and reviews specific to each episode in a given feed 152. The review may be a rating such as a “star” rating and may include additional descriptions provided by users.

In addition to maintaining information specific to series and individual episodes within the series, the feed database 174 may also include information associated with publishers of the feeds, sponsors of the feeds, or people in the feeds.

The subscription management server 118 includes a feed search engine 172. The feed search engine 172 provides a graphical user interface to users allowing the user to search for and subscribe to feeds 152 using the subscription management server 118. The graphical user interface may be an .HTML or WAP page served to the device 101 or computing device 103 for display to the user via a browser. WAP refers to the Wireless Application Protocol, which is an open international standard for applications that use wireless communication (for example, Internet access from a mobile phone). WAP was designed to provide services equivalent to a web browser with some mobile-specific additions, being specifically designed to address the limitations of very small portable devices.

Alternatively, the graphical user interface may be presented to the user through some other software on the device 101, 103. An example of a podcast search engine and its graphical user is discussed in commonly assigned U.S. patent application Ser. No. 11/346,777, filed Feb. 2, 2006, which application is hereby incorporated herein by reference. Through the graphical user interface, the feed search engine 172 receives user search criteria. The search engine 172 then uses these parameters to identify feeds 152 that meet the user's criteria. The search may involve an active search of Internet through the use of a web crawler, a search of the feed database 174, or some combination of both 174. The search may include a search of the descriptions provided in the feed 152 of the series and each particular episode in the series. The search may also include a search of the tags and other information associated with feeds 152 listed in the feed database 174, but not provided by the feeds themselves. The results of the search are then displayed to the user via the graphical user interface.

The architecture 100 also includes a number of servers 150 that publish podcasts. That is, the servers 150 include one or more feeds 152, such as RSS feeds, that are accessible through the network, in this case the Internet 104. The feeds 152, as will be described in greater detail below, include information about the feed (e.g., series information) as well as information about the various media files 154 (i.e., episodes) of the feed 152. The feed 152 also identifies the media files 154 so that they can be retrieved by an aggregator. The media file 154 may reside on the podcast server 150 with the feed 152, or may be located on another server 156.

As illustrated in FIG. 2, each user's device 102, 103, 106, the subscription management server 118 and podcast servers 150, as well as the other servers 156 are communicatively connected via the Internet 104. In alternate embodiments, different components of the architecture 100 may be communicatively coupled differently, for example each may be coupled directly to each other wirelessly or by a local or wide area network (WAN) or the like. Additionally, functional components can be distributed so that certain functions of the media engine may be performed at subscription management server 118, or vice versa, or distributed in modular fashion for operation at various locations throughout the architecture 100. Thus, the description herein of a function or component being associated with a particular device or component or location is merely exemplary.

The architecture 100 further includes a subscription management engine 180. In an embodiment the subscription management engine 180 may allow a user to determine what future episodes of a feed will be presented to the user. The subscription management engine 180 allows a user to select filter criteria that the subscription management engine 180 will then use to identify future episodes that are of interest to the user. In addition, the subscription management engine 180 may also automatically prevent the user from being presented with and possibly receiving future episodes that do not interest the user, thus, saving the user time and effort. In an alternative embodiment, the subscription management engine 180 may also limit the episodes that are automatically delivered to the user's device 103, thereby conserving the user's device resources.

In the embodiment shown in FIG. 2, the subscription management engine 180 resides on the subscription management server 118 and accessed by a user via the Internet 104. As discussed above, in an alternative embodiment the subscription management engine 180 may reside on the user's computing device 103.

In an embodiment, the subscription management engine 180 may use the user's device information to determine where to transmit a notification of a new episode or the new episode itself. Thus, the subscription management engine 180 may use user selections of preferred devices for delivery of different episodes as another filter for delivery of notifications and episodes.

In an embodiment, users interact with the subscription management engine 180, such as via graphical user interface as described below, to create one or more profiles or “customized subscriptions.” In an embodiment, subscription management engine 180 allows users to name each customized subscription as it is created to differentiate it from other customized subscriptions a user may create. When creating a customized subscription, the user is prompted to select one or more feeds, select and/or register one or more destination devices 102, 103, 106 and then select filter criteria for filtering future episodes in the selected feeds. Then, as discussed in FIG. 1, as new episodes are listed in the selected feeds, the episodes are compared to the filter criteria, to determine if they should be presented to the user or not.

As part of the creation process, the subscription management engine 180 stores the relevant information including information related to the user creating the customized subscription, the feed or feeds selected, the device or devices identified, and the filter criteria selected. Any other information provided by the user may also be stored, such as whether the user has indicated a preferred media file type.

The customized subscription information is stored in a data store accessible to the subscription management engine 180. For example, in the embodiment shown in FIG. 2, the subscription management engine 180 may store the customized subscription information in the user information database 170 and associate it with the user that created the customized subscription. In an alternative embodiment, the subscription management engine 180 may store the information in a cookie on the user's computing device or in a separate data store dedicated to holding the customized subscription information.

The subscription management engine 180 compares the filter criteria to information known about the episode. Filter criteria may include such descriptive information as keywords, tags, popularity scores or ratings. For example, a filter criterion may be a keyword that appears in the published description of a new episode contained in the feed. A filter criterion may be that the episode meet or exceed a minimum rating score based on ratings received by a ratings system. Tags may also be used as filter criteria such that only episodes tagged with one or more specified tags meet the criteria.

The subscription management engine 180 may compare the filter criteria only to the published description of an episode contained in the feed, may compare the filter criteria to other sources of information about the episode, or both. For example, the subscription management engine 180 may compare the filter criteria to all the information in the feed database 174 associated with the episode. This may be in addition to comparing the filter criteria to the information in the feed or may be performed instead of comparing the filter criteria to the feed.

The subscription management engine 180 allows users to create many different customized subscriptions for different purposes. The customized subscriptions may be limited to a single feed so that the user only gets episodes from that feed regarding a specific topic at a specific device 102, 103, 106. In addition, a customized subscription may cover multiple feeds in order to obtain episodes from the selected feeds meeting certain filter criteria via a single subscription. For example, a user may create a “CU Football” customized subscription that filters the user's favorite college football feeds for episodes related to the University of Colorado football program. This prevents the user from being notified of or having to retrieve and download episodes from multiple feeds in order to find only those episodes relating the user's topic of interest.

In an embodiment utilizing a mobile device 101, after creation of the customized subscription the subscription management system generates and transmits notifications and/or episodes in the customized subscription to the user's mobile device 101. In this way, the user can control what episodes within a feed are delivered to the user's mobile device 101, thereby conserving resources on the device 101.

In order to provide customized subscriptions, the subscription management engine 180 may, or may not, create an identifiable file structure that corresponds to the customized subscription. In one embodiment, discussed in greater detail below, the subscription management engine 180 may create an actual feed, referred to as a derivative feed, to which the user may subscribe. In an alternative embodiment, the subscription management engine 180 may not create any identifiable file structure, but rather programmatically generates and delivers information as necessary (such as in response to requests from a user's device) to a user. In this alternative embodiment, the user's device is subscribed to a non-existent feed and requests for updates to the non-existent feed are handled by the subscription management engine 180. In either embodiment, there is no difference as far as the user and the user's device are concerned.

In an embodiment, in order to receive episodes or notifications, a user will have to register a device 102, 103, 106 with the subscription management server 118. Such a registration may be automatic when the user accesses the interfaces of the subscription management engine 180 with the device. In an alternative embodiment, a user may have to explicitly register a device 102, 103, 106, such as by providing a telephone number or other ID associated with the device.

Registration may further include the transmitting of software to the device being registered. Such software may be selected based on the capabilities and type of device 102, 103, 106 being registered, e.g., based on the make and model of the device and/or the software operating system and other applications already installed on the device. In order to be able to provide the appropriate software, the subscription management server 118 includes or has access to a software database 176. The software database 176 includes different versions of software in order to provide the appropriate software for any mobile device 101 that may be registered.

In an embodiment, the architecture includes a communication module 190 that can communicate with the wireless systems that support the communications to the mobile device. Such a communication module may be designed to use the Internet 104 to connect with the wireless communication system or may be designed to access the wireless communication system 192, 194 directly through a direct communication link that excludes the Internet 104. In an embodiment, the communication module may be provided by and co-located with the subscription management engine 180 or may be a separate and independent module. The communication module 190 may be a third party resource, implemented on the subscription management server 118 (as shown in FIG. 2) or provided by the wireless communication system 192, 194.

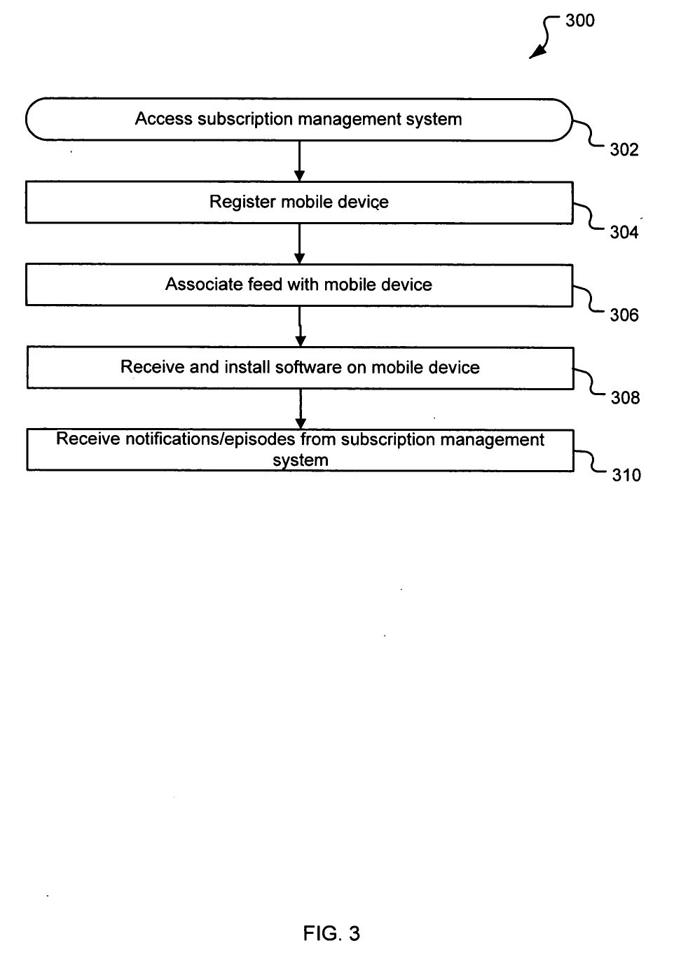

FIG. 3 illustrates an embodiment of a method for pushing new episodes to a mobile device. The method 300 shown illustrates an embodiment of operations performed to have new episodes of a podcast pushed automatically to his mobile device.

For the sake of example and not by way of limitation, the embodiment of the method 300 is described in terms of a mobile device that is a cellular telephone. The cellular telephone may be of the type that is referred to as a “smart phone.” The cellular telephone is adapted to receive and store content files, such as music, video or audio files and playback (i.e., render) such files. The cellular phone may include software, hardware, firmware or some combination. In the embodiment described below, the cellular phone will be described as having a combination of hardware (e.g., a processor, a transceiver, a display, a speaker, a microphone, mass storage and memory) and software (e.g., display drivers, an operating system, and a media player) that work together to perform the functions of the telephone.

As part of the method 300, a user accesses the subscription management system in an access operation 302. In an embodiment, the user may access the subscription management system from the user's computing device 103. Alternatively, the user may access the subscription management system with the cellular telephone if the cellular telephone is web-enabled. Access may include using a browser to access a web page associated with the subscription management system, and through which information about the cellular telephone and the user is provided to the subscription management system. Alternatively, the subscription management system may be accessed by transmitting an e-mail to a specific e-mail address, by transmitting a text message, such as through the Short Message Service (SMS) or comparable protocol or service, to a specific telephone number that is associated with the subscription management system, by transmitting message generated from a user's selection of control on a WAP (wireless application protocol) page displayed on the mobile device, or by transmitting a message generated by an application executing on the mobile device.

The user then registers the cellular phone with the subscription management system in a registration operation 304 by providing the necessary information to the subscription management system. It is through the registration operation 304, that the subscription management system is made aware of the cellular telephone and is provided the information necessary to contact the cellular phone.

In an embodiment, the registration operation 304 includes the user providing the telephone number of the cellular phone to the subscription management system. Alternatively, some other identifier of the cellular phone may be provided. Examples of alternative identifiers to telephone numbers include the Electronic Serial Number (ESN) of the phone and the Mobile Identification Number (MIN), possible in combination with a System Identification Code (SID). In some cellular phones, the ESN is a unique 32-bit number programmed into the phone when it is manufactured; the MIN is a 10-digit number derived from your phone's number; and the SID a unique 5-digit number that is assigned to each carrier by the Federal Communications Commission. Other identifiers could also be used.

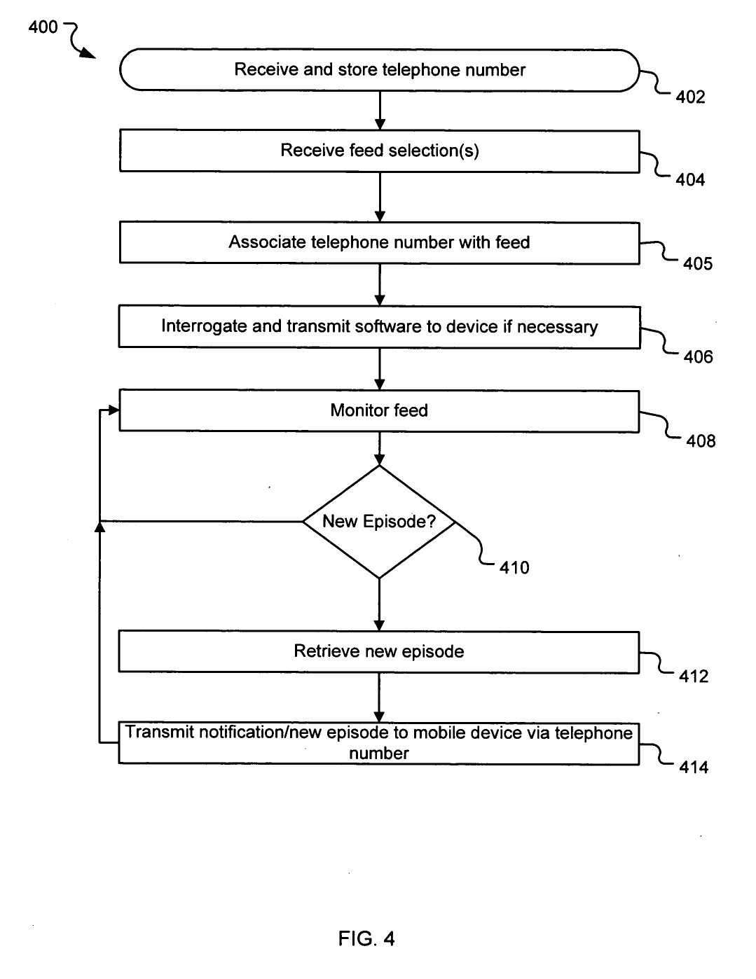

The method 300 also includes an association operation 306 in which the user expressly associates one or more feeds with the user's cellular telephone. As discussed in greater detail below with reference to FIG. 4, the subscription management system stores this information so that the cellular telephone is notified of any new episodes in the selected feed.

The association operation may also include the user providing preferences to the subscription management system of how and what should be pushed to the user's cellular phone. In an embodiment, the user identifies a feed from the user's account subscription list maintained by the subscription management system and selects it to be pushed to the user's cellular phone. Alternatively, a user may select a new feed.

In addition to selecting the feed, the user may be able to select what information is to be pushed to the cellular telephone. For example, the user may select to receive only notifications of new episodes instead of the episodes themselves. The user may further be able to select the form of the notification, such as text messages indicating that a new episode is available and containing a link or other means for expressly retrieving the episode with the cellular phone. Alternatively, the user may select to have new episodes pushed to the phone automatically.

A user may also indicate the form of the media (e.g., a media file type preference) to be provided by the subscription management system. For example, the user may select to have high resolution or low resolution versions of new episodes delivered, where possible, depending on the user's preference assuming that the cellular phone is capable of rendering either. In an alternative embodiment, the form may be dictated by the user's device and may be automatically selected by the subscription management system.

As described above, depending on the method through which the subscription management system is accessed, the information required for registration and association of the cellular phone may be provided in an e-mail, in a text message, through a graphical user interface (GUI) on a web page, or by keypad entry in response to prompts as part of a phone call to a telephone number.

In the embodiment shown, the method 300 includes an optional operation 308 of receiving software from the subscription management system in a receive and install software operation 308. In this embodiment, software compatible with the user's cellular phone is selected by the subscription management system and transmitted to the cellular phone in some way. For example, the subscription management system may transmit a text message including a link or other means through which the user may download the software to the phone. Alternatively, an e-mail may be transmitted to the user with an attachment to be copied to the user's phone. In yet another embodiment, the user is provided a telephone number to call or some other location to access with the cellular telephone in order to obtain the software. The software is then installed, if necessary, on the cellular phone. Methods of transmitting and installing software onto a mobile device such as a cellular phone are known in the art and any suitable method may be used.

The software may be a software application or a “plug-in” that is designed to work with software already on the phone. The software may also include information, such as account names, user IDs, passwords or other information necessary for receiving and rendering the episodes. The software may need to be continuously executed in the background of the phone to perform its function or may be automatically executed by cellular phone in response to receipt of a notification from the subscription management system.

The receive and install software operation 308 is only necessary if the cellular phone is not capable or already provided with software capable of receiving and/or rendering media from the subscription management system. For example, some cellular phones may include this capability automatically and, hence, not need the additional software.

After registering the cellular phone and performing any other operations necessary, the subscription management system will transmit notifications or new episodes as directed by the user to the cellular phone. As described in greater detail below, when the subscription management system determines that a new episode is available using its search engine, it then generates a notification and/or transmits the new episode to the cellular phone.

The notification/new episode is then received in a receive notification/new episode operation 310. The receive notification/new episode operation 310 may include receiving a message transmitted through the cellular phone's cellular communication system using the cellular phone's telephone number to find the cellular phone regardless of its physical location. Other methods of receiving a notification/new episode have been described above.

Depending on the embodiment, the new episode may be received from the subscription management server or may be received from the source of the new episode, e.g., a third party server 150, 156 which stores the new episode. Furthermore, depending on the embodiment, the new episode may be automatically received, may need to be expressly requested by the user (using the information from the notification), or may be automatically requested by the cellular phone (such as by the software in response to and based on the processing of the information in the notification).

The receive notification/new episode operation 310 may include automatically storing the received data, be it simply a notification or the new episode. The user is then free to use that data to obtain or to render the new episode using the cellular phone as the rendering device.

FIG. 4 illustrates an embodiment of a method for pushing new episodes to a mobile device. The embodiment of the method 400 shown includes operations performed by the subscription management system or associated components in registering the mobile device and pushing the new episodes to the mobile device. As discussed above, the embodiment is described in the context in which a cellular phone is the mobile device although the operations described can be easily extrapolated to different mobile devices.

Registration of a cellular phone by the subscription management system includes receiving the telephone number (and/or other identifying information) in a receive telephone number operation 402. As described above, depending on how the user chooses to access the subscription management system the telephone number may be provided through an e-mail message, an HTTP request generated through interaction with a GUI provided by the subscription management server, a telephone call or an SMS text message.

The subscription management system will also receive a selection of one or more feeds to be associated with the cellular phone in a receive feed selection operation 404. As discussed above, depending on how the user chooses to access the subscription management system the feed selection may be provided through an e-mail message, an HTTP request, a telephone call or an SMS text message.

The receive telephone number operation 402 and the receive feed selection operation 404 may be combined into a single operation or performed as separate and distinct operations, possibly from different devices. For example, a feed selection may be made by a user via a personal computer through a web site served by the subscription management system, after which the user may provide the telephone number by calling in or text messaging a number provided by the subscription management system for that purpose.

Additional directions, preferences or other information may also be provided to the subscription management system in either the receive telephone number operation 402 or the receive feed selection operation 404. Such information may be filter criteria for content (only provide new episodes in the feed that contain a keyword, for instance), data format criteria (only provide content in the .MPEG file format), or size criteria (only provide the first 500 Kb of data, the rest being requested later when the content is rendered).

Communications with the subscription management system may be facilitated by a GUI displayed to the user, an automated telephone call interface system or some other interface between the user and the subscription management system. The interface used may be determined by the type of device through which the user chooses to access the subscription management system and be designed to facilitate communications with that device. For example, a user with a personal computer or a web-enabled mobile device may communicate through interactions with a web page (HTML or WAP, for instance) GUI of the subscription management system. As another example, a data-enabled application executing on the mobile device may transmit messages directly to the subscription management system.

The subscription management system, upon receipt of all information then associates the telephone number with the selected feed or feeds in an association operation 405. This may include storing the telephone number, a user identifier, and the feed information in a database of subscription information, such as the user database described above. In an embodiment, a user identifier to be associated with the telephone number may be contained in the same communication or determined based on the context of communication or how the communication was received. The telephone number is then stored so that it is associated with the user identifier.

In an alternative embodiment, there may be no explicit user identifier associated with the telephone number so that the only association made is that between the feed and the telephone number as described below. The subscription management system may create and assign a transaction number or create a “dummy” identifier to be associated with the telephone number, or may simply use the telephone number as the identifier. In this way, no user may be directly associated with the telephone number and the user may be essentially anonymous as far as the registered users are concerned.

In any case, the subscription management system creates the association between the selected feed(s) and the telephone number. This information and association is then maintained until such time as the user expressly discontinues the association (such as by deleting the user's account or directing the subscription management system to end the association) or the subscription management system discontinues the account (such as due to non-use, due to failed attempts to communicate with the telephone number, or because of delinquency in payment for the service).

The subscription management system may also interrogate (explicitly or implicitly) or otherwise determine if software is needed on the cellular phone to receive new episodes from the subscription management system in a software operation 406. If it is determined that software is necessary, then it is transmitted to the device and installed as was described above.

To make the determination, the software operation 406 may include interactions with the user, such as communications prompting the user to reply and identify the make and model of the phone to the subscription management system. Alternatively, the subscription management system may automatically request this information or receive this information from the phone as part of earlier operations. In yet another alternative embodiment, the subscription management system may request this information from a third party, such the manufacturer, carrier or service provider associated with the phone.

The software operation 406 may include transmitting a text message containing information on how to download the software to the mobile device, such as a user-selectable control that generates a request from the mobile device to the subscription management system. Such a request is then received from the mobile device by the subscription management system, to which the subscription management system responds by transmitting the appropriate software.

As discussed above, such software may be selected from a store of different software based on the capabilities of the mobile device and information known or obtained from the mobile device. The selection may be made using a lookup table containing a listing of different types of mobile devices, software, or other information about mobile devices and associating each with a compatible software application. Alternatively, the selection may be made by interfacing with the manufacturer of the mobile device to determine a recommended software application.

In an alternative embodiment (not shown), the software may be provided to the phone in an initial operation so that the other operations described in FIG. 4 are performed with the assistance of the software from the cellular phone. For example, the first step in registration may be for the user to obtain the software and install it on the cellular phone. The remaining operations in the registration are then performed using an interface provided by the software.

The subscription management system, using the feed crawler or other modules or capabilities associated with the feed search engine, then monitors the feeds selected for and associated with the telephone number in a monitor operation 408. Thus, the cellular telephone need not also monitor the feeds, thereby relieving it of the need to use connection time in periodic connections to many different feeds. Instead, the cellular telephone at most need only to communicate with the subscription management system. The cellular telephone also need not have any podcatching software.

Monitor operation 408 may include periodically or occasionally comparing the feed(s) at the third party server(s) with information stored by the subscription management system. The comparison may include accessing the feed, obtaining a copy of or a portion of the feed file. The accessing may be done on a regular period or occasionally, in response to such as user requests, system load, or knowledge received from other sources. In an alternative embodiment, the subscription management system may log into the third party server(s) to receive notifications of updates, where possible, so that the subscription management system does not have to actively monitor the feed.

Occasionally during the monitoring operation 408, the subscription management system will determine that a new episode has been added to a feed associated with the telephone number in a determination operation 410. The determination operation 410 may include comparing a copy of the feed file with a previous copy or comparing existing episodes listed in the feed file with information stored on the system, such as a previously stored episode list for the feed or a list of episodes previously transmitted to the telephone. If the determination operation 410 determines that a new episode has been added then the filter or other preference criteria may be inspected to determine if a new episode meeting the filter and other preference criteria has been added. If not, then the subscription management system returns to monitoring the feeds in the monitoring operation 408.

If the subscription management system determines that a new episode meeting the filter and other preference criteria has been added, then a notification is transmitted to the cellular phone identified by the telephone number (or alternatively the mobile device identified by the identification information) associated with the feed in a transmit operation 414. The transmit operation 414 may include transmitting an e-mail message, an HTTP request, a telephone call, a message from an application on the cellular phone or an SMS text message to the wireless network serving the cellular phone.

Alternatively, the transmit operation 414 may be performed in response to a periodic request for updates from the cellular phone. In this embodiment, the cellular phone may periodically, or in response to a user request, send an update request message to the subscription management system. Receipt of this update request causes the subscription management system to transmit any previously untransmitted notifications or episodes as described above. In addition, this may include performance of the monitoring operation 408, the determination operation 410, and the retrieve new episode operation 412 in response to receiving the update request so the information transmitted is current.

The transmit operation 414 may also include transmitting the notification and transmitting the episode separately, and possibly by different communication channels. For example, the notification may be transmitted as a telephone call, while the episode is by a data connection to the cellular phone. Alternatively, the notification may be transmitted by a text message communication channel while the episode is by a data connection to the cellular phone. Other combinations of separately transmitting notifications and episodes on different communication channels and at different times are also possible and within the scope of this disclosure.

In the embodiment described, the telephone number is used in order to provide the communications network enough information to physically locate the cellular phone using the cellular communication network. Thus, the telephone number is used by the subscription management system to identify to the communications network that the mobile device is the destination of the communication (e.g., the notification or the new episode itself. Thus, the subscription management system is relieved of the need of maintaining any information about the mobile device other than its telephone number. The wireless network and telephone network are then responsible for correlating the telephone number with the mobile device and to deliver the notification/new episode to the mobile device. In the situation where the telephone network needs a communication to be in a specific form or format, the communication module of the subscription management system may ensure that the communications are formatted as required.

As described below, the notification may include the new episode, may simply alert the user that the new episode is available or may provide information usable by the phone to obtain a copy of the new episode, either directly from the third party server or from the subscription management system.

A user may prefer to receive the new episode automatically as the subscription management system becomes aware of the new episode. In the embodiment shown in FIG. 4, a retrieve new episode operation 412 is provided in which the new episode is retrieved by the subscription management system. The new episode may then be transmitted to the cellular phone, for example at the same time the notification generated and transmitted as part of the transmit operation 414.

Alternatively, the notification may include information allowing the cellular phone to access the copy of the new episode from the subscription management system, such as via a command to the software provided by subscription management system in the software operation 406. For example, in an embodiment a user may have a smart phone, but may not have direct access to the Internet. The software provided by the subscription management system would allow the user to receive notifications from the subscription management system and, through the software, download the new episodes either automatically or in response to user commands. In this way, the smart phone may receive new episodes indirectly from the third party server.

In an embodiment, the services provided by the subscription management system are free to the users of the mobile devices. In that embodiment, the services may be provided as a loss leader to generate user traffic on one or more systems associated with the subscription management system or provide a greater range of services for a cellular phone service.

Alternatively, the cost of operating the subscription management system may be offset by providing advertisements with the new episodes. For example, advertisements may be provided in simple pop-ups or by a more complicated system such as that described in commonly assigned U.S. patent application Ser. Nos. 11/347,046, 11/347,626 and 11/347,625 directed at inserting and selecting advertisements for use with media content, which applications are hereby incorporated herein by reference. The advertisers, then, would pay the subscription management system for advertisement placements, such as on a per advertisement basis or some other negotiated contract term.

In another embodiment, the services provided by the subscription management system may be provided at a fee to the user. Such a fee may be automatically charged to the user's cellular phone/wireless service and paid when the user pays his monthly cellular phone carrier/wireless service provider bill.

Those skilled in the art will recognize that the methods and systems of the present invention within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

For example, the subscription management system may allow a user to subscribe to advertising-free feeds for one fee or to feeds with advertisements for a lower fee or for free. In that embodiment, the customized subscription system may include an access and billing module through which users may request access to an advertising-free subscription, and automatically be charged for and subscribed to the subscription. Such an access and billing module may further automatically pay or credit the creator/publisher of the subscription so that the entire transaction is handled electronically and without any user intervention other than the initial request.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known variations as would be understood by those skilled in the art.

What is claimed is:

1. A method of delivering episodes of a subscription to a mobile device on a wireless network comprising:
maintaining, by a subscription management system remote from a mobile device, user data associating a telephone number of a mobile device with at least one user-selected subscription maintained at a computing device remote from the subscription management system and the mobile device;
determining that a new episode has been added to one of the at least one user-selected subscription; and
transmitting, by the subscription management system, a notification of the new episode to the wireless network, the notification associated with the telephone number, thereby delivering the notification to the mobile device via the wireless network.

2. The method of claim 1 further comprising:
receiving, by the subscription management system, a telephone number of a mobile device;
transmitting software to the mobile device;
associating the telephone number with a user and the at least one user-selected subscription based on information provided by the user; and
wherein the software is adapted to receive and process the notification from the subscription management system.

3. The method of claim 1 wherein the user-selected subscription corresponds to a feed file accessible via the computing device, the feed file containing a list episodes and episode locations.

4. The method of claim 3 wherein associating further comprises:
identifying existing episodes, existing episodes being episodes listed in the feed at the time of the associating.

5. The method of claim 1 further comprising:
maintaining a record of new episodes transmitted to the mobile device.

6. The method of claim 2 wherein determining further comprises:
occasionally inspecting the feed.

7. The method of claim 1 further comprising:
retrieving the new episode from a remote computing device; and
transmitting the new episode to the mobile device.

8. The method of claim 1 wherein the notification includes the new episode.

9. The method of claim 2 further comprising:
receiving, by the subscription management system, a request for transmission of the new episode from the software executing on the mobile device, the request generated in response to and based on information in the notification.

10. The method of claim 2 wherein receiving a telephone number comprises:
receiving a telephone call from the mobile device via the wireless network.

11. The method of claim 2 wherein receiving a telephone number comprises:
receiving a text message from the mobile device via the wireless network.

12. The method of claim 2 wherein receiving a telephone number comprises:
receiving an electronic message from the mobile device via the wireless network.

13. The method of claim 12 wherein receiving a telephone number comprises:
receiving an electronic message from a user device different from the mobile device, the electronic message containing information identifying the telephone number of the mobile device.

14. The method of claim 2 wherein opening a connection comprises:
initiating a telephone call to the telephone number.

15. The method of claim 2 wherein transmitting software to the mobile device comprises:
transmitting a text message containing information on how to download the software to the mobile device; and
receiving a request from the mobile device to download the software, the request generated from the information.

16. The method of claim 2 wherein transmitting software to the mobile device comprises:
receiving a request from the mobile device to download the software, the request including information related to software compatibility; and
selecting the software from a set of different software applications based on the information.

17. The method of claim 2 further comprising:
receiving a request from the software to associate the telephone number with a user profile, the user profile identifying the at least one user-selected subscription.

18. The method of claim 1 wherein transmitting a notification further comprises:
transmitting an advertisement to the mobile device.

19. A subscription management system comprising:
a server adapted to retrieve episodes from one or more remote computing devices and transmit retrieved episodes to a mobile device over a wireless network via a telephone number associated with the mobile device;
a datastore, in communication with the server, containing at least one telephone number of a mobile device associated with a user and at least one subscription associated with the user, the at least one subscription corresponding to a podcast accessible via one of the one or more remote computing devices, the podcast listing episodes; and
a search module adapted to identify that a new episode has been listed in the podcast;
wherein the server is adapted to retrieve the new episode based on information in the podcast and transmit the new episode to the mobile device associated with the user when the search module identifies the new episode.

20. The system of claim 19 further comprising:
a subscription module adapted to receive telephone numbers from the user and associate the telephone number with the user.

21. The system of claim 19 further comprising:
a communications module adapted to connect to a telephone network and transmit data via the telephone network to the mobile device of the mobile device.

22. The system of claim 19 further comprising:
a plurality of software applications, each software application adapted to be transmitted to and executed on a mobile device, each software application when executed on a mobile device adapted to receive the new episode and store the new episode on the mobile device for future consumption by the user.

23. The system of claim 22 further comprising:
a means for selecting one of the plurality of software applications based on information identifying the mobile device provided to the server.

24. The system of claim 19 wherein the search module further comprises:
a means for accessing the podcast and comparing the podcast to stored information related to the podcast.

25. A method comprising:
transmitting a first telephone number of a mobile device to a subscription management system on a first remote computing device;
associating a feed located on a second remote computing device with the first telephone number of the mobile device; and
thereby receiving on the mobile device, from the subscription management system via a wireless network, new episodes listed in the feed located at the second remote computing device as the episodes become available.

26. The method of claim 25 wherein transmitting further comprises:
accessing the subscription management system from a third remote computing device.

27. The method of claim 25 wherein transmitting further comprises:
accessing the subscription management system from the mobile device.

28. The method of claim 27 wherein transmitting further comprises:
calling a second telephone number, the second telephone number associated with the subscription management system.

29. The method of claim 25 wherein associating further comprises:
selecting the feed via a user interface of the subscription management system.

30. The method of claim 25 wherein associating further comprises:
selecting a user profile via a user interface of the subscription management system, the user profile identifying the feed.

31. The method of claim 25 wherein transmitting further comprises:
receiving software at the mobile device, the software transmitted to the mobile device via the wireless network based on the first telephone number.

32. The method of claim 25 wherein receiving episodes further comprises:
receiving a notification of the new episodes listed in the feed located at the second remote computing device as the episodes become available.

33. The method of claim 25 wherein each new episode is automatically transmitted from the subscription management system to the wireless network in a communication that identifies the first telephone number as the destination of the new episode.

34. A method of delivering episodes of a subscription to a mobile device on a wireless network comprising:
maintaining, by a subscription management system remote from a mobile device, user data associating a mobile device identifier of a mobile device with at least one user-selected subscription maintained at a computing device remote from the subscription management system and the mobile device;
determining that a new episode has been added to one of the at least one user-selected subscription; and
transmitting, by the subscription management system, a notification of the new episode to the wireless network, the notification associated with the mobile device identifier, thereby delivering the notification to the mobile device via the wireless network.

35. The method of claim 34 further comprising:
receiving, by the subscription management system, the mobile device identifier of the mobile device;
transmitting software to the mobile device;
associating the mobile device identifier with a user and the at least one user-selected subscription based on information provided by the user; and
wherein the software is adapted to receive and process the notification from the subscription management system.

36. The method of claim 34 wherein the user-selected subscription corresponds to a feed file accessible via the computing device, the feed file containing a list episodes and episode locations.

37. The method of claim 35 wherein determining further comprises:
occasionally inspecting the feed.

38. The method of claim 34 further comprising:
retrieving the new episode from a remote computing device; and
transmitting the new episode to the mobile device.

39. The method of claim 34 wherein the notification includes the new episode.

40. The method of claim 35 wherein receiving a mobile device identifier comprises:
receiving a telephone call from the mobile device via a wireless telephone network.

41. The method of claim 35 wherein receiving a mobile device identifier comprises:
receiving a text message from the mobile device via the wireless telephone network.

42. The method of claim 35 wherein receiving a mobile device identifier comprises:
receiving an electronic message from the mobile device via the wireless network.

43. The method of claim 42 wherein receiving a mobile device identifier comprises:
receiving an electronic message from a user device different from the mobile device, the electronic message containing information identifying the mobile device identifier of the mobile device.

44. The method of claim 35 further comprising:
receiving a request from the software to associate the mobile device identifier with a user profile, the user profile identifying the at least one user-selected subscription.

45. The method of claim 34 wherein transmitting a notification further comprises:
transmitting an advertisement to the mobile device.
